(19) United States
(12) Patent Application Publication
(10) Pub. No.: US 2020/0098250 A1
(43) Pub. Date: Mar. 26, 2020

(54) MANAGEMENT DEVICE, ENVIRONMENT SENSING SYSTEM, MANAGEMENT METHOD, AND PROGRAM RECORDING MEDIUM

(71) Applicant: NEC CORPORATION, Tokyo (JP)

(72) Inventor: Masayuki SATOU, Tokyo (JP)

(73) Assignee: NEC CORPORATION, Tokyo (JP)

(21) Appl. No.: 16/495,688

(22) PCT Filed: Mar. 19, 2018
(86) PCT No.: PCT/JP2018/010744

§ 371 Date: Sep. 19, 2019

(30) Foreign Application Priority Data
Mar. 23, 2017 (JP) 2017-057749

(51) Int. Cl. G08B 29/18

(52) U.S. Cl. CPC G08B 29/188

(57) ABSTRACT

The present invention secures reliability of environmental information detected by a sensor apparatus. A management device 100 includes: a reception unit 110 that receives first environmental information and second environmental information, which are transmitted from a sensor apparatus; and a control unit 120 that executes a control to limit the use of the first environmental information transmitted from the sensor apparatus in the cases where it is determined, on the basis of the second environmental information, that the environment surrounding the sensor apparatus has changed.

### TECHNICAL FIELD

The present disclosure relates to a management device or the like.

### BACKGROUND ART

As one type of a so-called Internet of things (IoT) device, there is a sensor apparatus called an environmental sensor. The environmental sensor described herein is a sensor that acquires information indicating an environment (temperature, humidity, brightness or the like) around the sensor. A network, in which a plurality of such environmental sensors are connected to one another is also referred to as a sensor network (for example, see PTL 1).

When there are a plurality of IoT devices in various places, it may be difficult to manage the IoT devices. For example, the IoT devices have the possibility of unauthorized use such as theft (for example, see PTL 2). As an anti-theft technology, for example, there has been known a technology in which any unauthorized movement of a vehicle is determined based on imaged data and is notified (for example, see PTL 3).

### CITATION LIST

### Patent Literature

[PTL 1] Japanese Unexamined Patent Application Publication No. 2016-048417 A

[PTL 2] International Publication No. WO 2016/172492

[PTL 3] Japanese Unexamined Patent Application Publication No. 2006-290172 A

### SUMMARY OF INVENTION

### Technical Problem

There is a case where an environmental sensor needs to perform sensing at a specific place. In such a case, when the environmental sensor is moved to another place, there is a problem that the reliability of data is reduced. Also, there is a problem that an authorized value may be recorded in the environmental sensor by mischief or the like of the third party. For example, environmental information such as temperature and brightness may be intentionally changed by warming the environmental sensor or covering the environmental sensor with a cover. However, the anti-theft technology as disclosed in PTL 3 does not solve problems specific to such a sensor apparatus.

An exemplary object of the present disclosure is to secure the reliability of environmental information detected by a sensor apparatus.

### Solution to Problem

According to an aspect, a management device is provided. The management device includes: reception means configured to receive first environmental information and second environmental information transmitted from a sensor apparatus; and control means configured to perform control to limit use of the first environmental information transmitted from the sensor apparatus when it is determined based on the second environmental information that there is a change in an environment around the sensor apparatus.

According to another aspect, an environment sensing system is provided. The environment sensing system includes: a sensor apparatus and a management device, wherein the sensor apparatus comprises: transmission means configured to transmit first environmental information and second environmental information to the management device, the management device comprises: reception means configured to receive the first environmental information and the second environmental information transmitted from the transmission means; and control means configured to perform control to limit use of the first environmental information transmitted from the sensor apparatus when it is determined based on the second environmental information that there is a change in an environment around the sensor apparatus.

According to further another aspect, a management method is provided. The management method includes the steps of: receiving first environmental information and second environmental information transmitted from a sensor apparatus; and performing control to limit use of the first environmental information transmitted from the sensor apparatus when it is determined based on the second environmental information that there is a change in an environment around the sensor apparatus.

According to further another aspect, a program recording medium that records a program is provided. The program causes a computer to perform: a step of receiving first environmental information and second environmental information transmitted from a sensor apparatus; and a step of performing control to limit use of the first environmental information transmitted from the sensor apparatus when it is determined based on the second environmental information that there is a change in an environment around the sensor apparatus.

### Advantageous Effects of Invention

According to the present disclosure, the reliability of environmental information detected by a sensor apparatus is secured.

### BRIEF DESCRIPTION OF DRAWINGS

FIG. 1 is a block diagram illustrating an example of a configuration of a management device.

FIG. 2 is a flowchart illustrating an example of an operation of a management device.

FIG. 3 is a block diagram illustrating an example of a configuration of an environment sensing system.

FIG. 4 is a flowchart illustrating an example of an operation of a cloud system.

FIG. 5 is a flowchart illustrating a first example of an operation of an environmental sensor.

FIG. 6 is a flowchart illustrating a second example of an operation of an environmental sensor.

FIG. 7 is a flowchart illustrating a third example of an operation of an environmental sensor.

FIG. 8 is a block diagram illustrating an example of a hardware configuration of a computer device.

### EXAMPLE EMBODIMENT

### First Example Embodiment

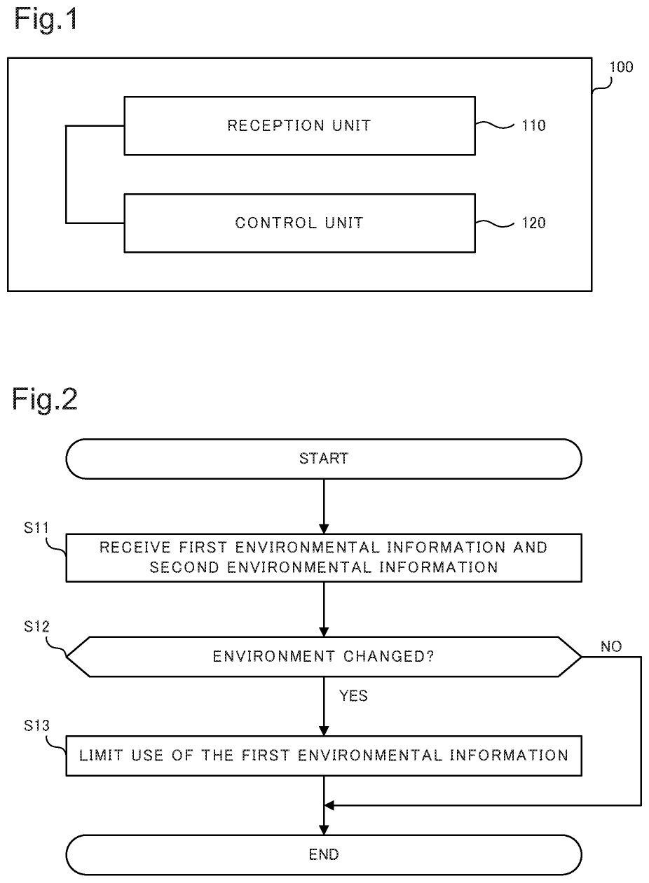

FIG. 1 is a block diagram illustrating a configuration of a management device 100 according to an example embodiment. The management device 100 is a computer device for managing environmental information transmitted from one or more sensor apparatuses. The management described herein includes taking measures to secure the reliability of the environmental information. Specifically, the management described herein includes limiting the use of the environmental information, which may be unauthorized, as necessary. The management device 100 includes at least a reception unit 110 and a control unit 120.

The sensor apparatus of the present example embodiment is an apparatus for detecting the environmental information. The environmental information described herein is information capable of detecting an environmental change. The environmental information, for example, is a physical amount of temperature, humidity, illuminance or the like. Furthermore, the environmental information may be image information indicating an image imaged by an image sensor or distance information indicating a distance between an object and the sensor apparatus.

The reception unit 110 receives the environmental information transmitted from the sensor apparatus. The reception unit 110 may also receive the environmental information via a wired or wireless network, or may also receive the environmental information directly (that is, without the intervention of another device) from the sensor apparatus. The reception unit 110 is configured to be able to receive the environmental information from one or more sensor apparatuses. Each sensor apparatus is installed at a specific place. In other words, it can be said that the reception unit 110 receives environmental information sensed at the specific place.

The reception unit 110 receives a plurality of types of environmental information from one sensor apparatus. Alternatively, the reception unit 110 may receive different types of environmental information from a plurality of sensor apparatuses which may be regarded to be actually located at the same place. The environmental information received by the reception unit 110 includes two types (or more) environmental information. Hereinafter, for the convenience of description, the environmental information received by the reception unit 110 is classified into “first environmental information” and “second environmental information”.

The first environmental information is environmental information to be mainly detected in the present example embodiment. The first environmental information may be different depending on the purpose of sensing, but for example, includes temperature, humidity, illuminance, atmospheric pressure, ultraviolet light, sound (sound pressure), concentration of a specific component in the atmosphere, or the like. The first environmental information may be information measured in the soil or underwater (soil moisture, water temperature or the like).

The second environmental information is information for determining the validity of the first environmental information in the present example embodiment. It can be said that the second environmental information is environmental information which is a detection target subordinate (to the first environmental information). The second environmental information, for example, represents an image obtained by imaging the periphery of the sensor apparatus. The image described herein is not limited to a visible image, and for example, may be a thermographic image obtained by visualizing infrared rays emitted from an object. Alternatively, the second environmental information may represent a distance between an object and the sensor apparatus.

It can be said that the second environmental information is information less likely to change compared to the first environmental information. Alternatively, in the case of satisfying a predetermined condition (which may be unauthorized), it can be said that the second environmental information is information that changes more significantly than other cases. In other words, it can be said that the first environmental information is information that may change regardless of whether it may be unauthorized. That is, it can be said that the second environmental information has a higher correlation with unauthorization than the first environmental information.

The control unit 120 controls the use of the environmental information. In the present example embodiment, the use of the environmental information refers to collection, processing, analysis or the like of the environmental information, and various arithmetic processes that can be applied to the environmental information may correspond thereto. Furthermore, the use described herein may be use in the management device 100, but may be use in another device. Alternatively, the subject of the use described herein may not be a machine but a human being.

When it is determined that there is an environmental change around a certain sensor apparatus, the control unit 120 performs control to limit the use of the first environmental information transmitted from the sensor apparatus. More specifically, when it is determined that there is the environmental change around the certain sensor apparatus, the control unit 120 may discard the first environmental information transmitted from the sensor apparatus, or may control the sensor apparatus so as not to transmit the first environmental information. That is, the control of the control unit 120 may include allowing another device to perform a specific process (or not to perform the specific process). The sensor apparatus includes a transmission means.

Based on the second environmental information, the control unit 120 determines an environment change around the sensor apparatus. In other words, it can be said that, based on the second environmental information, the control unit 120 determines whether to limit the use of the first environmental information. That is, the second environmental information is used as a reference for determining whether to limit the use of the first environmental information.

FIG. 2 is a flowchart illustrating the operation of the management device 100. The management device 100 performs the following process while communicating with the sensor apparatus. In step S11, the reception unit 110 receives the first environmental information and the second environmental information from a certain sensor apparatus. In step S12, the control unit 120 determines whether there is an environmental change around the sensor apparatus. Based on the second environmental information received in step S11, the control unit 120 performs this determination.

It is determined that there is the environmental change around the sensor apparatus (S12: YES), the control unit 120 performs step S13. In step S13, the control unit 120 performs control to limit the use of the first environmental information received in step S11. On the other hand, it is determined that there is no environmental change around the sensor apparatus (S12: NO), the control unit 120 skips step S13. That is, in such a case, the use of the first environmental information is not limited.

The determination of step S12 may also be performed in another device different from the management device 100. In such a case, the other device notifies the management device 100 of the determination result of step S12. Based on the notified determination result, the management device 100 performs step S13 as necessary.

As described above, the management device 100 of the present example embodiment has a configuration of determining whether to limit the use of the first environmental information, based on the second environmental information. According to such a configuration, when an environmental change around the sensor apparatus is implied by the second environmental information, it is possible to limit the use of the first environmental information received together with the second environmental information. In this way, the management device 100 can secure the reliability of the environmental information detected by the sensor apparatus.

### Second Example Embodiment

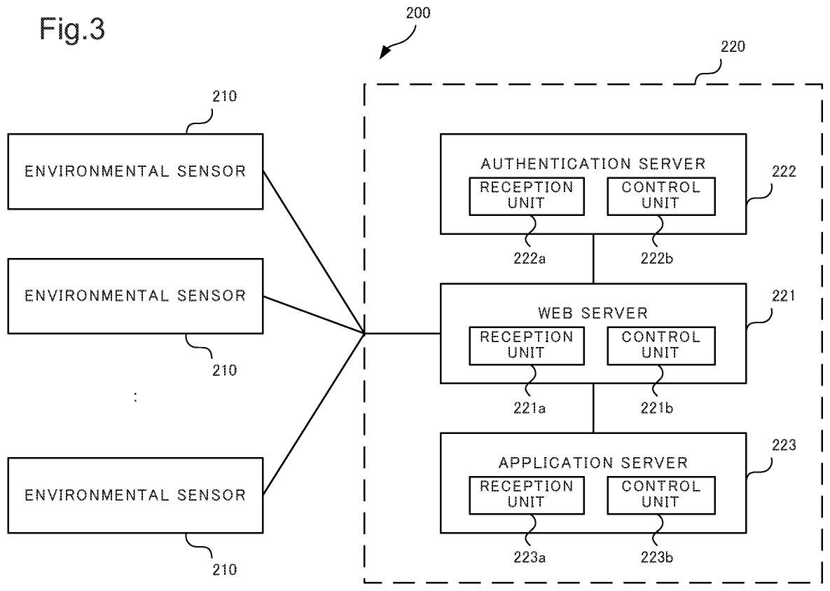

FIG. 3 is a block diagram illustrating a configuration of an environment sensing system 200 according to another example embodiment. The environment sensing system 200 includes a plurality of environmental sensors 210 and a cloud system 220. More specifically, the cloud system 220 includes a Web server 221, an authentication server 222, and an application server 223. The environmental sensors 210 and the cloud system 220 are connected to each other via a predetermined communication network. The cloud system 220 may have a firewall on a communication path with the environmental sensors 210. In the present example embodiment, the cloud system 220 corresponds to an example of the management device 100 of the first example embodiment. At least one server included in the cloud system 220 includes an execution means.

The environmental sensor 210 is a sensor apparatus having an arithmetic device including one or more sensor elements, an image sensor, a communication module or the like. The environmental sensor 210 transmits environmental data generated by the sensor elements and image data generated by the image sensor to the cloud system 220. In the present example embodiment, the environmental data corresponds to an example of the first environmental information of the first example embodiment. Furthermore, the image data corresponds to an example of the second environmental information of the first example embodiment. The environmental data is not particularly limited; however, in the following, it is assumed that the environmental data is data representing temperature, humidity or the like.

The plurality of environmental sensors 210 are installed at specific places, respectively. That is, the environmental sensors 210 are installed on the assumption that they do not move from the specific places. It can be said that the environmental sensors 210 generate and output environmental data corresponding to the installed places.

The Web server 221 receives the environmental data and the image data from the environmental sensors 210. Furthermore, the Web server 221 transmits the environmental data to the application server 223 and transmits the image data to the authentication server 222. Furthermore, when a predetermined condition is satisfied, the Web server 221 limits the use of the environmental data by the application server 223. Also, the Web server 221 can remotely control the environmental sensors 210.

The authentication server 222 performs an authentication process, based on the image data. It can be said that the authentication process described herein is a process of determining the validity of the environmental data sensed by the environmental sensors 210. Furthermore, the authentication server 222 performs a learning process of learning image features extracted from the image data prior to the authentication process. The authentication server 222 can access a database in which image features are recorded. The database may be included in the authentication server 222, but may also be included in a device different from the authentication server 222.

The application server 223 provides a predetermined service by using the environmental data. The application server 223 performs a process required for providing the service using the environmental data, by using a predetermined application program. For example, the application server 223 can record the environmental data, perform an arithmetic process on the environmental data, or visualize the environmental data (allow the environmental data to be viewed) in a predetermined format.

The Web server 221, the authentication server 222, and the application server 223 are distinguished from one another for the purpose of convenience. The functions of the Web server 221, the authentication server 222, and the application server 223 may be implemented by a single device. Furthermore, the cloud system 220 may include a plurality of Web servers 221, authentication servers 222, or application servers 223

The Web server 221 includes a reception unit 221a and a control unit 221b. The authentication server 222 includes a reception unit 222a and a control unit 222b. The application server 223 includes a reception unit 223a and a control unit 223b. The reception units 221a, 222a, and 223a correspond to an example of the reception unit 110 of the first example embodiment. The control units 221b, 222b, and 223b correspond to an example of the control unit 120 of the first example embodiment. The reception units 222a, and 223a receive date transmitted from the environmental sensors 210 via the Web server 221, but can also receive the date from the environmental sensors 210 without the intervention of the Web server 221.

The configuration of the environment sensing system 200 is as described above. Based on the configuration, the environmental sensors 210 transmit the environmental data and the image data to the cloud system 220 at a predetermined timing. For example, the environmental sensors 210 repeatedly transmit the environmental data and the image data to the cloud system 220 at predetermined time intervals such as 10-minute intervals or 1-hour intervals. The environmental data and the image data may not always be transmitted at the same timing.

The cloud system 220 performs a predetermined process, based on the environmental data and the image data transmitted from the environmental sensors 210. Furthermore, the cloud system 220 provides a predetermined service (a cloud service) using the environmental data in response to a request from a client. The specific content of the service is not particularly limited, but for example, may include providing information, which is obtained based on the environmental data, for viewing.

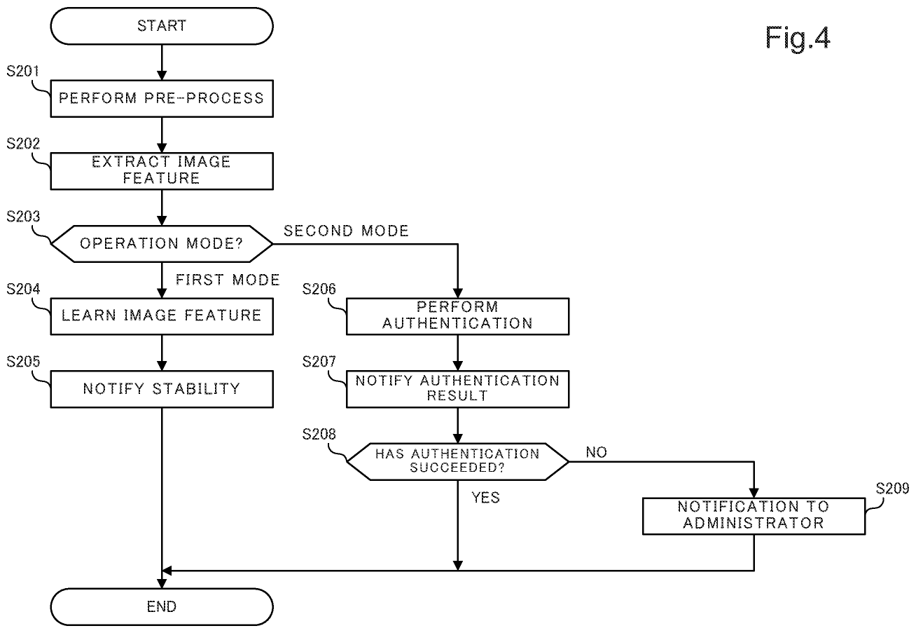

FIG. 4 is a flowchart illustrating the operation of the cloud system 220. The cloud system 220 performs the process of FIG. 4 whenever the image data is received during the providing of the service. That is, the process of FIG. 4 is a loop process that is repeatedly performed in the cloud system 220.

In step S201, the Web server 221 performs a pre-process on the image data. The pre-process described herein, for example, includes removing a noise component (water droplets, dirt or the like) included in an image represented by the image data, adjusting of brightness corresponding to imaging conditions, or the like.

In step S202, the Web server 221 extracts image features. The image features described herein are features of points, lines, or regions extracted from an image by using a predetermined algorithm. The image features extracted in step S202, for example, may be corners extracted by a Harris method, a Kanade-Lucas-Tomasi (KLT) method or the like, lines (contours or the like) by edge emphasis, or regions extracted by binarization, K means clustering or the like.

Steps S201 and S202 may also be performed by the authentication server 222 instead of the Web server 221. Furthermore, the Web server 221 may not perform step S201 depending on the imaging environment or imaging conditions of the environmental sensor 210.

In step S203, the authentication server 222 determines an operation mode of the environmental sensor 210. Then, the authentication server 222 performs different processes in response to the operation mode. In the present example embodiment, there are three types of operation modes. Furthermore, the operation mode may be different for each environmental sensor 210. That is, an environmental sensor 210 and another environmental sensor 210 may operate in operation modes different from each other.

A first mode is a mode for learning the image features. In the following, the first mode is also referred to as a “learning mode”. A second mode is a mode for safely operating the environmental sensor 210 after the completion of the learning in the learning mode. In the following, the second mode is also referred to as a “security mode”. A third mode is a mode for limiting the use of the environmental data when a predetermined mode is satisfied in the security mode. In the following, the third mode is also referred to as a “standby mode”.

In step S203, the authentication server 222 determines whether the operation mode is the learning mode or the security mode. When the operation mode is the learning mode (S203: the first mode), the authentication server 222 performs steps S204 and S205. On the other hand, when the operation mode is the security mode (S203: the second mode), the authentication server 222 performs steps S206, S207 and S208.

In step S204, the authentication server 222 learns the image features extracted in step S202. It can be said that this learning process is a process of determining a reference available in authentication to be described below. In step S205, the authentication server 222 notifies the environmental sensor 210 of the stability of the learning. The stability described herein is a numerical value indicating the degree of the learning of the image features. That is, a state with a high degree of stability means a state in which the image features of an environment have been learned. When the stability exceeds a predetermined threshold value, the environmental sensor 210 switches the operation mode from the learning mode to the security mode.

The learning of step S204, for example, is performed as follows. Hereinafter, it is assumed that the image data has W pixels in the width direction and H pixels in the height direction and is data representing a color image in which each pixel is expressed in gradation by the luminance values of three colors of R (red), G (green), and B (blue).

The image data can be regarded as a multidimensional vector with the number of elements of 3×W'H. The authentication server 222 can convert multidimensional image data into lower-dimensional (for example, two-dimensional) data by applying principal component analysis to the image data. The authentication server 222 uses the converted data as image feature data. Two pieces of image feature data means that it is a similar image as the distance (the Euclidean distance) therebetween is small. The authentication server 222 generates one cluster by collecting image feature data that is close in distance. The process of generating the cluster by so doing corresponds to an example of the learning described in the present example embodiment.

In this example, the number of image feature data constituting the cluster can be used for stability. Consequently, in such a case, when the number of image feature data constituting the cluster exceeds a certain value, the environmental sensor 210 switches the operation mode from the learning mode to the security mode. The cluster generated as described above can be used as a reference in the authentication to be described below.

In step S206, the authentication server 222 performs the authentication by comparing the image features extracted in step S202 with the reference generated by the learning process. For example, in the case of an example using the aforementioned principal component analysis and clustering, the authentication server 222 calculates a distance between the image feature data obtained based on the image data transmitted from the environmental sensor 210 and the cluster generated by the learning process, and compares the calculated distance with a predetermined threshold value.

When the distance is smaller than the threshold value, it means that the image represented by the image data transmitted from the environmental sensor 210 is similar to the reference. In such a case, the authentication server 222 determines that an environment determined from the image data is substantially the same as at the time of learning. Consequently, in such a case, the authentication server 222 determines that the authentication has succeeded.

On the other hand, when the distance between the image feature data and the cluster is equal to or more than the threshold value, the authentication server 222 determines that the environment determined from the image data is not substantially the same as at the time of learning. For example, when a foreign object (including a person) not reflected on the image is reflected or when the position of the environmental sensor 210 is changed (that is, is moved) and a imaged scene is changed, the distance between the image feature data and the cluster may be equal to or more than the threshold value. In such a case, the authentication server 222 determines that the authentication has failed.

In step S207, the authentication server 222 notifies the environmental sensor 210 of the authentication result. That is, the authentication server 222 notifies the environmental sensor 210 of whether the authentication has succeeded or failed. In step S208, the authentication server 222 determines whether the authentication has succeeded or failed, and ends the process when the authentication has succeeded (S208: YES).

On the other hand, when the authentication has failed (S208: NO), the authentication server 222 performs step S209. In step S209, the authentication server 222 notifies an administrator of the environment sensing system 200 of the fact that the environment determined from the image data is not substantially the same as at the time of learning, that is, it is determined that the environment has changed. The notification to the administrator, for example, is performed by transmitting an electronic mail to a communication terminal of the administrator. A method for the notification to the administrator in step S209 is not limited to a specific method.

The administrator confirms an environmental sensor 210 for which the authentication has failed, and performs a reset as necessary. For example, the administrator confirms unauthorized movement of the environmental sensor 210 or presence or absence of a foreign object around the environmental sensor 210. The administrator may remotely perform such confirmation work or may visually perform such confirmation work while going toward the installation place of the environmental sensor 210.

When the administrator confirms that the environmental sensor 210 has no problem (or any problem has been solved), the administrator resets the environmental sensor 210. The environmental sensor 210 may be configured to be remotely reset or may have a reset button.

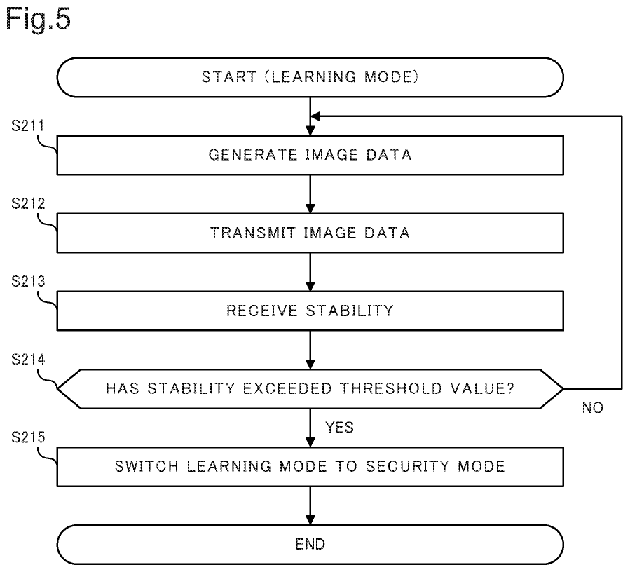

FIG. 5 is a flowchart illustrating the operation of the environmental sensor 210. Particularly, FIG. 5 illustrates the operation of the environmental sensor 210 when the operation mode is the learning mode. In step S211, the environmental sensor 210 generates image data obtained by imaging the periphery of the sensor. In step S212, the environmental sensor 210 transmits the image data generated in step S211 to the cloud system 220. Based on the image data transmitted in step S212, the cloud system 220 performs step S204 (that is, learning).

In step S213, the environmental sensor 210 receives stability as a learning result from the cloud system 220. The stability corresponds to the stability notified in step S205. In step S214, the environmental sensor 210 determines whether the stability received in step S213 is equal to or less than a predetermined threshold value.

When the stability is equal to or less than the predetermined threshold value (step S214: NO), the environmental sensor 210 performs the processes after step S211 again. Consequently, the environmental sensor 210 repeatedly performs the image data transmission or the like until the stability exceeds the predetermined threshold value. On the other hand, when the stability exceeds the predetermined threshold value (step S214: YES), the environmental sensor 210 performs step S215. In step S215, the environmental sensor 210 switches the operation mode from the learning mode to the security mode.

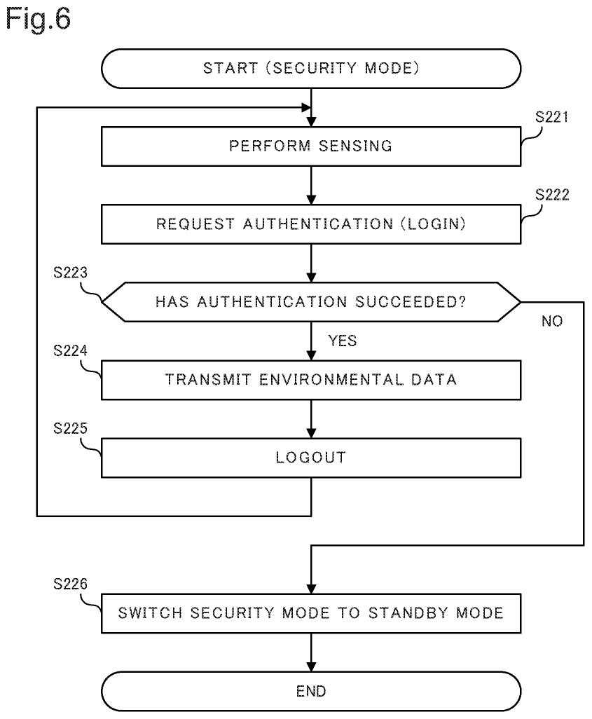

FIG. 6 is a flowchart illustrating the operation of the environmental sensor 210 in the security mode. In step S221, the environmental sensor 210 senses environmental data. In step S222, the environmental sensor 210 requests the cloud system 220 to perform authentication. That is, it can be said that the environmental sensor 210 attempts to log in to the cloud system 220.

As described above, the cloud system 220 performs the authentication by using the image data. Consequently, the environmental sensor 210 transmits the image data to the cloud system 220 at the request of step S222. Based on the image data, the cloud system 220 performs the authentication of step S206 and the notification of step S207.

In step S223, the environmental sensor 210 determines an authentication result and performs a process corresponding to the authentication result. Specifically, when the authentication has succeeded, that is, when the login to the cloud system 220 has succeeded (S223: YES), the environmental sensor 210 performs steps S224 and S225. On the other hand, when the authentication has failed (S223: NO), the environmental sensor 210 performs step S226.

In step S224, the environmental sensor 210 transmits environmental data. In this step, the environmental sensor 210 may transmit data other than the environmental data or receive data from the cloud system 220. In step S225, the environmental sensor 210 logs out of the cloud system 220. In such a case, the environmental sensor 210 performs the processes after step S221 again.

The environmental sensor 210 may always sense the environmental data, but may sense the environmental data only for a required timing (for example, from a request for logging in to the cloud system 220 to logging out). In any cases, the environmental sensor 210 repeatedly logs in to the cloud system 220 (for example, at predetermined time intervals). That is, while the operation mode is in the security mode, the environmental sensor 210 repeatedly and continuously transmits the environmental data to the cloud system 220.

On the other hand, in step S226, the environmental sensor 210 switches the operation mode from the security mode to the standby mode. That is, when the authentication has failed, the environmental sensor 210 operates in the standby mode.

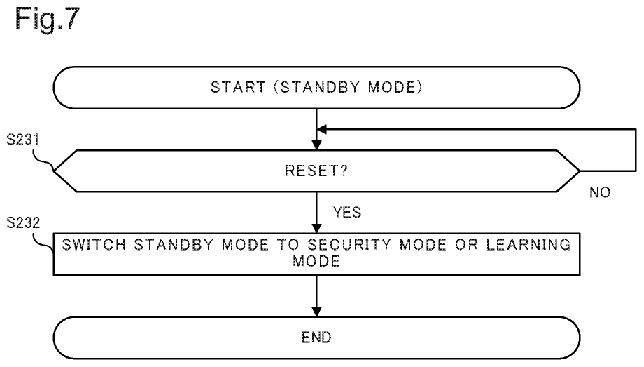

FIG. 7 is a flowchart illustrating the operation of the environmental sensor 210 in the standby mode. In step S231, the environmental sensor 210 determines whether a reset has been performed by the administrator. As described above, the administrator can reset the environmental sensor 210 by operating the environmental sensor 210 directly or remotely.

The environmental sensor 210 repeats the determination of step S231 until a reset is performed by the administrator. On the other hand, when the reset has been performed by the administrator, the environmental sensor 210 performs step S232. In step S232, the environmental sensor 210 switches the operation mode from the standby mode to the security mode or the learning mode. That is, the environmental sensor 210 may also switch the operation mode to a mode (the security mode) immediately before being switched to the standby mode, or may switch the operation mode to the security mode once, determine whether there is no environmental change, and then switch the operation mode to the security mode.

As described above, the environment sensing system 200 according to the present example embodiment has a configuration of determining, based on the second environmental information (image data), whether to limit the use of the first environmental information (environmental data), similarly to the management device 100 of the first example embodiment. Consequently, according to the environment sensing system 200, it is possible to secure the reliability of the environmental data detected by the environmental sensors 210.

For example, in the environment sensing system 200, when it is determined based on the image data that there is an environmental change, the environmental sensor 210 switches the operation mode from the security mode to the standby mode and limits the transmission of environmental data. In this way, the environmental sensor 210 can allow the environmental data when it is determined that there is the environmental change to be unavailable in the cloud system 220.

Furthermore, according to the environment sensing system 200, when it is determined that the position of the environmental sensor 210 has changed, it is possible to limit the use of environmental data. Consequently, according to the environment sensing system 200, it is possible to prevent confusion between environmental data sensed at a specific place and environmental data sensed at a place different from the specific place.

Furthermore, the environment sensing system 200 has a configuration of determining an environmental change around the environmental sensor 210, based on image features. This configuration enables determination based on overall tendency regardless of a fine difference in a imaged image. In this way, the environment sensing system 200 can improve the accuracy of authentication.

### Modification Example

The aforementioned first and second example embodiments, for example, can employ the following modifications. These modification examples can also be appropriately combined as necessary.

(1) The environmental sensor 210 may also include a transmitter or a receiver of ultrasonic waves or millimeter waves (hereinafter, also referred to as “ultrasonic waves or the like”), instead of the image sensor. For example, the environmental sensor 210 may also measure a distance to a specific object by using the ultrasonic waves and transmit distance information indicating the measured distance to the cloud system 220 instead of image data. In such a case, the cloud system 220 determines that a case where the distance indicated by the distance information is within the range of predetermined upper limit value and lower limit value is valid.

Furthermore, the environmental sensor 210 may include a receiver that receives the ultrasonic waves or the like transmitted from a transmitter provided in the vicinity of the environmental sensor 210, and may be shifted to the standby mode when it is not possible to receive the ultrasonic waves or the like. In such a case, the cloud system 220 determines an environmental change, based on whether the environmental sensor 210 can receive the ultrasonic waves or the like.

(2) The cloud system 220 may also determine an environmental change, based on a relative positional relation between a plurality of environmental sensors 210. For example, the environment sensing system 200 may also include an environmental sensor 210 (hereinafter, also referred to as a “first sensor”) that transmits the ultrasonic waves or the like and an environmental sensor 210 (hereinafter, also referred to as a “second sensor”) that receives the ultrasonic waves or the like transmitted from the first sensor. In such a case, when the second sensor is not able to receive the ultrasonic waves or the like (to be originally received) transmitted from the first sensor, the cloud system 220 may also determine that environments of these sensors have changed (that is, at least one of these sensors has moved).

Alternatively, the environmental sensor 210 may also be configured to image other nearby environmental sensors 210. In such a case, a marker may be attached to the environmental sensor 210 in order to easily specify displacement or inclination. In such a case, the cloud system 220 can determine an environmental change, based on the position of the environmental sensor 210 included in a imaged image.

(3) The cloud system 220 may switch a communication network, via which the environmental sensor 210 is connected to the cloud system 220, in response to the operation mode. Also, in such a configuration, it is possible to limit the use of environmental data when a predetermined condition is satisfied.

For example, in the security mode, the cloud system 220 sets a communication network used by the environmental sensor 210 as a network accessible to the authentication server 222 and the application server 223. On the other hand, in the standby mode, the cloud system 220 sets the communication network used by the environmental sensor 210 as a network accessible to the authentication server 222 but not accessible to the application server 223. The communication network described herein, for example, is a virtual local area network (VLAN).

(4) The specific hardware configurations of the devices (the management device 100 and the cloud system 220) according to the present disclosure include various variations and are not limited to specific configurations. For example, the devices according to the present disclosure may also be implemented using software or may be configured to share various processes by using a plurality of hardware.

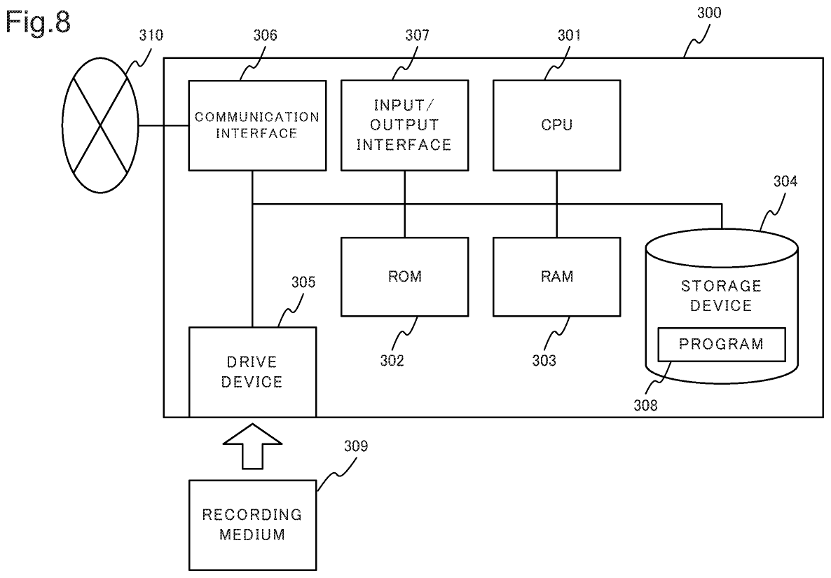

FIG. 8 is a block diagram illustrating an example of a hardware configuration of a computer device 300 that implements the devices according to the present disclosure. The computer device 300 includes a central processing unit (CPU) 301, a read only memory (ROM) 302, a random access memory (RAM) 303, a storage device 304, a drive device 305, a communication interface 306, and an input/output interface 307.

The CPU 301 executes a program 308 by using the RAM 303. The communication interface 306 exchanges data with an external device via a network 310. The input/output interface 307 exchanges data with peripheral equipment (an input device, a display device or the like). The communication interface 306 and the input/output interface 307 can serve as constituent elements for acquiring or outputting data.

The program 308 may be stored in the ROM 302. Furthermore, the program 308 may be recorded on a recording medium 309 such as a memory card, and may be read by the drive device 305 or transmitted from the external device via the network 310.

The devices according to the present disclosure can be implemented by the configuration (or a part thereof) illustrated in FIG. 8. For example, in the case of the management device 100, the reception unit 110 corresponds to the communication interface 306. Furthermore, the control unit 120 corresponds to the CPU 301, the ROM 302, and the RAM 303.

The constituent elements of the devices according to the present disclosure may be configured by a single circuitry (a processor or the like), or may be configured by a combination of a plurality of circuitries. The circuitry described herein may be any one of a dedicated circuitry and a general-purpose circuitry. For example, in the devices according to the present disclosure, a part may be implemented by a dedicated processor and another part may be implemented by a general-purpose processor.

(5) So far, the present invention has been described employing the aforementioned example embodiments and modification examples as exemplary examples. However, the present invention is not limited to these example embodiments and modification examples. The present invention may include example embodiments employing various modifications or applications which can be understood by a so-called person skilled in the art within the scope of the present invention. Furthermore, the present invention may include example embodiments in which matters described in the present specification are appropriately combined or replaced as necessary. For example, matters described using specific example embodiments can also be applied to other example embodiments without inconsistency.

This application is based upon and claims the benefit of priority from Japanese patent application No. 2017-057749, filed on Mar. 23, 2017, the disclosure of which is incorporated herein in its entirety by reference.

### REFERENCE SIGNS LIST

100 management device

110 reception unit

120 control unit

200 environment sensing system

210 environmental sensor

220 cloud system

221 Web server

222 authentication server

223 application server

300 computer device

1. A management device comprising:
a memory storing a computer program; and
one or more processors configured to run the computer program to perform:
receiving first environmental information and second environmental information transmitted from a sensor apparatus; and
performing control to limit use of the first environmental information transmitted from the sensor apparatus when it is determined based on the second environmental information that there is a change in an environment around the sensor apparatus.

2. The management device according to claim 1, wherein
the one or more processors are configured to run the computer program to perform:
the control when it is determined based on the second environmental information that there is a change in a position of the sensor apparatus.

3. The management device according to claim 1, wherein the second environmental information is image data obtained by imaging a periphery of the sensor apparatus, and
the one or more processors are configured to run the computer program to perform:
determining the change in the environment, based on an image feature extracted from the image data.

4. The management device according to claims 1, wherein
the one or more processors are configured to run the computer program to perform:
learning, in a first mode, the environment, based on the second environmental information, and
determining, in a second mode, the change in the environment, based on the second environmental information.

5. The management device according to claim 4, wherein
the one or more processors are configured to run the computer program to perform:
switching the first mode to the second mode when a state of the learning satisfies a predetermined condition in the first mode.

6. The management device according to claims 1, wherein
the one or more processors are configured to run the computer program to perform:
receiving the first environmental information and the second environmental information from a plurality of sensor apparatuses, and
determining the change in the environment, based on a relative positional relation between the plurality of sensor apparatuses.

7. The management device according to claims 1, comprising:
the one or more processors are configured to run the computer program to perform
a process by using the first environmental information.

8. (canceled)

9. A management method comprising the steps of:
receiving first environmental information and second environmental information transmitted from a sensor apparatus; and
performing control to limit use of the first environmental information transmitted from the sensor apparatus when it is determined based on the second environmental information that there is a change in an environment around the sensor apparatus.

10. A non-transitory program recording medium that records a program causing a computer to perform:
a step of receiving first environmental information and second environmental information transmitted from a sensor apparatus; and
a step of performing control to limit use of the first environmental information transmitted from the sensor apparatus when it is determined based on the second environmental information that there is a change in an environment around the sensor apparatus.
